(19) United States
(12) Patent Application Publication
(10) Pub. No.: US 2010/0178231 A1
(43) Pub. Date: Jul. 15, 2010

(54) Method of Sequestering Carbon Dioxide

(76) Inventors: Christian Stewart MacGregor Turney, Devon (GB); Ian Stewart Turney, Kaiapoi (NZ)

Correspondence Address: DANN, DORFMAN, HERRELL & SKILLMAN, 1601 MARKET STREET, SUITE 2400, PHILADELPHIA, PA, 19103-2307, US

(21) Appl. No.: 12/520,683

(22) PCT Filed: Dec. 21, 2007
(86) PCT No.: PCT/NZ07/00388

§ 371 Date: Mar. 16, 2010

(30) Foreign Application Priority Data
Dec. 22, 2006 (NZ) 552315

(51) Int. Cl. C01B 31/20

(52) U.S. Cl. 423/437.1

(57) ABSTRACT

The invention provides a method for sequestering carbon dioxide. The method comprises cutting organic material into chips, carbonising the chips of organic material by applying microwave energy and storing the resulting charcoal in a carbon sink.

### FIELD OF INVENTION

The present invention is directed to a method producing charcoal (also known as biochar or agrichar). In particular, the present invention is directed to a method of sequestration of carbon dioxide through the carbonisation of organic Material using microwave energy.

### BACKGROUND OF INVENTION

There is considerable concern over the current volume of greenhouse gas emissions and the effect that these may have on the global climate. Carbon dioxide (CO₂) is the principal greenhouse gas believed to be driving global warming and represents around 70% of all greenhouse gases generated globally.

To achieve lasting reductions, wide scale changes in the world's patterns of energy consumption will be needed. For example, use of renewable energy will need to be promoted, as well as increased energy efficiency and the development of fuel alternatives. However; in the short term, capturing and storing atmospheric carbon dioxide can provide a stop-gap mechanism

The capture of carbon gases for storage is referred to as “sequestration”. Sequestration of carbon in gaseous form (as the gas is released, for example at power plants) is a technically complex and high cost solution.

An alternative approach is to sequester carbon dioxide in trees by reforesting areas of land. On average between 40-50% of all material in trees is carbon. However, reforestation requires large areas of land to store relatively small amounts of carbon dioxide. In addition, the carbon dioxide that is stored in trees can only be held for typically less than 100 years even if the area remains forested. If the area is cleared, much of the carbon dioxide returns to the atmosphere.

There exists a need for a method of sequestering carbon dioxide that ameliorates one or more of the drawbacks of known methods of carbon sequestration described above, or that at least provides the public with a useful choice.

### SUMMARY OF INVENTION

In broad terms in one form the invention provides a method for sequestering carbon dioxide comprising:
cutting organic material into chips;
carbonising the chips of organic material by applying microwave energy; and storing the resulting charcoal in a carbon sink.

Preferably the organic material is plant material.

Preferably the method comprises the preliminary step of selecting organic material that is well-suited to fix carbon.

Preferably the chips of organic material are held in oxygen-restricting containment when the microwave energy is applied.

Preferably the carbon sink is a coal mine shaft.

Preferably the carbon sink is an open cast working mine.

Preferably the carbon sink is an exhausted oil reservoir.

Preferably the carbon sink is a soil to form terra preta.

Preferably the organic material is cut into chips in a chipper apparatus fuelled by bio-fuel.

Preferably the microwave energy is applied to the chips of organic material in a solar-powered microwave apparatus, or by some other renewable energy source.

In broad tetras in another form the invention provides a method for sequestering carbon dioxide comprising:

machine-chipping plant material, wherein the machinery used to chip the plant material is run on biofuel;

carbonising the chipped plant material in a solar-powered microwave oven.

The term “comprising” as used in this specification means “consisting at least in part of”. That is to say, when interpreting statements in this specification which include “comprising”, the features prefaced by this term in each statement all need to be present but other features can also be present. Related terms such as “comprise” and “comprised” are to be interpreted in a similar manner.

As used herein the term “and/or” means “and” or “of”, or both.

As used herein “(s)” following a noun means the plural and/or singular forms of the noun.

### BRIEF DESCRIPTION OF THE DRAWINGS

At least preferred embodiments of the invention will now be described with reference to the following drawings in which:

FIG. 1 is a flow diagram of preferred methods of the invention; and

FIG. 2 is a block diagram of the process flow for the invention.

FIGS. 3 and 4 show preferred form microwave apparatus.

### DETAILED DESCRIPTION OF THE INVENTION

The invention uses microwave technology to convert organic material such as wood into charcoal. When microwave energy is applied to plant material, microwaves pass through the plant material and heat all of its molecules simultaneously:This heat produces charcoal from the plant material. In charcoal, carbon becomes “fixed” and is capable of being stored long-term if nothing is done to release the carbon back into the atmosphere. By comparison, raw plant material will rot relatively easily, making it suitable generally for short-term storage only. Thus, sequestering carbon gases in charcoal rather than directly as unprocessed plant material increases the amount of time for which the carbon gases can be stored. By using microwaves, organic Material such as plants can be converted into charcoal in an energy efficient manner:

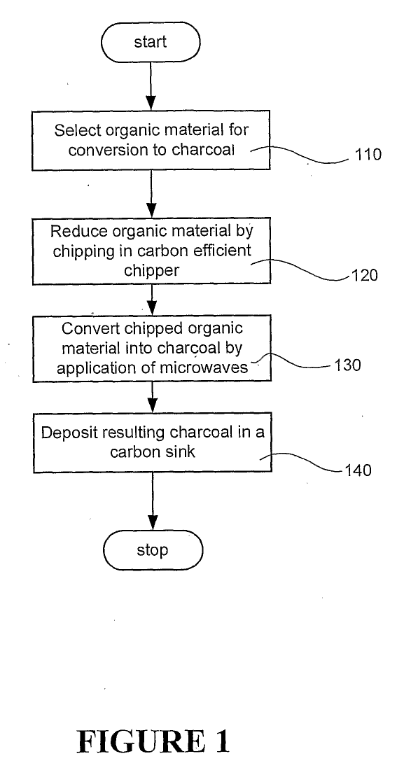

FIG. 1 is a flow diagram of the steps in at least one preferred embodiment of the invention. At 110, organic material, typically plant material such as wood, cereal plants, seaweed or organic waste, is selected for the sequestration process. Selection of organic material for the sequestration process is based on how effectively a particular type of organic material fixes carbon dioxide. In the case of plant material, such as trees, the effectiveness with which the plant material fixes carbon dioxide will typically be determined by assessing how much carbon dioxide is fixed over a particular growth period for the plant. More effective plants (such as trees) will fix the highest amount of carbon dioxide over the shortest possible growth period. Preferred vegetation includes evergreen and deciduous trees and shrubs.

Once the organic material has been selected, the next step is to reduce the size of the organic material into small chips as shown at 120. Preferably the organic material is chipped into the approximate dimensions 5 cm×2 cm×0.5 cm. It will be appreciated that the size will vary. Chipping the organic material makes it easier for the material to be converted into charcoal using microwave technology.

In some embodiments, the machinery used to reduce the organic material into chips uses a bio fuel, such as ethanol, or any other carbon efficient energy source. This improves the carbon efficiency of the sequestration process so that the process itself produces as little additional carbon gas as possible.

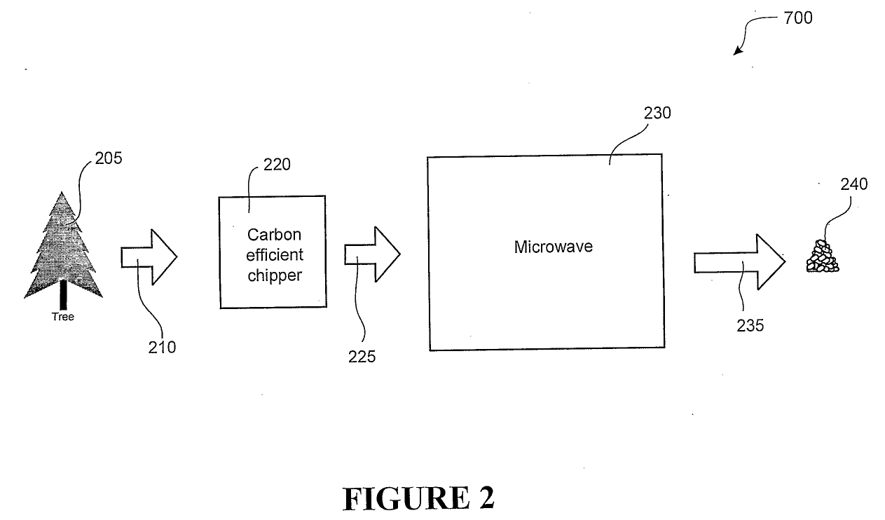

FIG. 2 is a block diagram illustrating a preferred form system 200 to facilitate the passage of the organic material through the sequestration process described in this specification. Organic material 205 is fed 210 into a carbon-efficient chipper or shredder 220.

As shown at 130 in FIG. 1, the next step is to place the chipped or shredded organic material into a microwave apparatus or oven and convert the material into charcoal by applying microwave energy. The microwave apparatus may be configured to remove moisture and other gases. For example, the microwave apparatus may include a condenser or catalytic converter to trap other gases emitted during heating. A suitable condenser or catalytic converter includes a honeycomb structure and zeolite.

Die chipped organic material is then positioned 225 inside microwave apparatus 230 where microwaves are applied to the organic material to convert the chipped organic material into charcoal. The finished product is removed 235 from microwave apparatus 230 as charcoal 240.

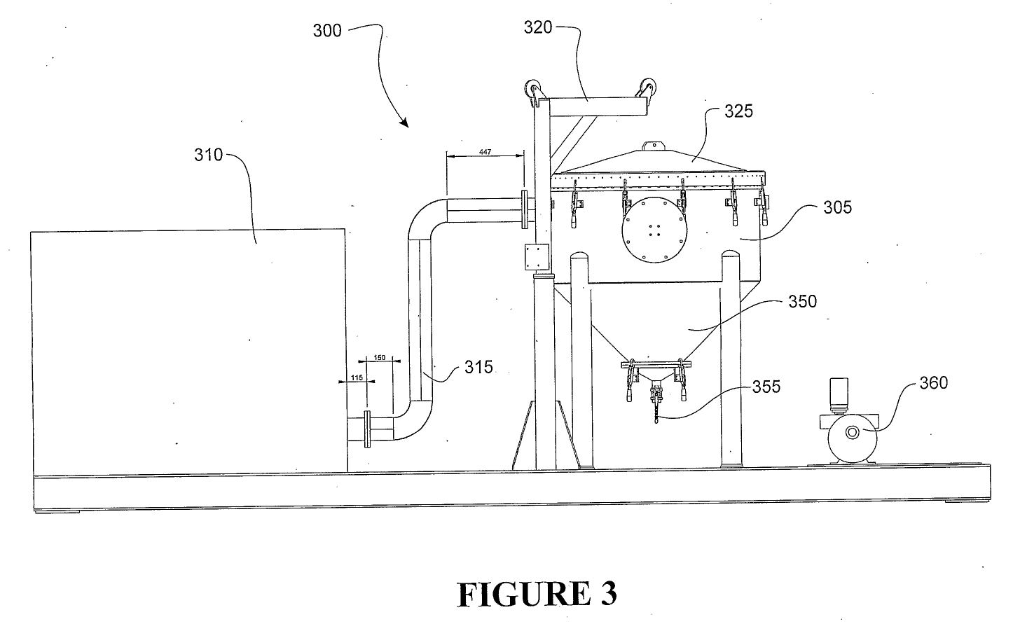

FIG. 3 shows a preferred faun microwave apparatus 300. Apparatus 300 is one preferred form embodiment of microwave apparatus 230. As shown in FIG. 3, apparatus 300 includes batch vacuum vessel 305, a microwave generator 310 and wave guide 315.

Microwave generator 310 is configured to generate electromagnetic radiation. Preferably the electromagnetic radiation has a frequency range of super high frequency (SHF) or extremely high frequency (EHF) that are typical of microwaves. Typical frequencies of the electromagnetic radiation are in the range 300 GHz to 3 GHz with wavelengths of between 1 min and 1 dm.

The electromagnetic radiation is produced by any suitable apparatus. Suitable apparatus includes klystron and magnetron tubes as well as solid state diodes.

The electromagnetic radiation generated by the microwave generator 310 is guided to the batch vacuum vessel 305 by a suitable wave guide 315. It is envisaged that the wave guide is constructed from either conductive or dielectric materials.

Apparatus 305 further includes a gantry 320 or similar structure for faciliating loading batches of chipped organic material into batch vacuum vessel 305. In one preferred form the chipped organic material is packed into a basket (not shown) sized to entirely locate within batch vacuum vessel 305. Lid 325 of vessel 305 is raised. The gantry 320 is used to locate the basket packed with chipped organic material within vessel 305. After the basket is located within the vessel 305 the lid 325 is sealed so that the vessel 305 is airtight.

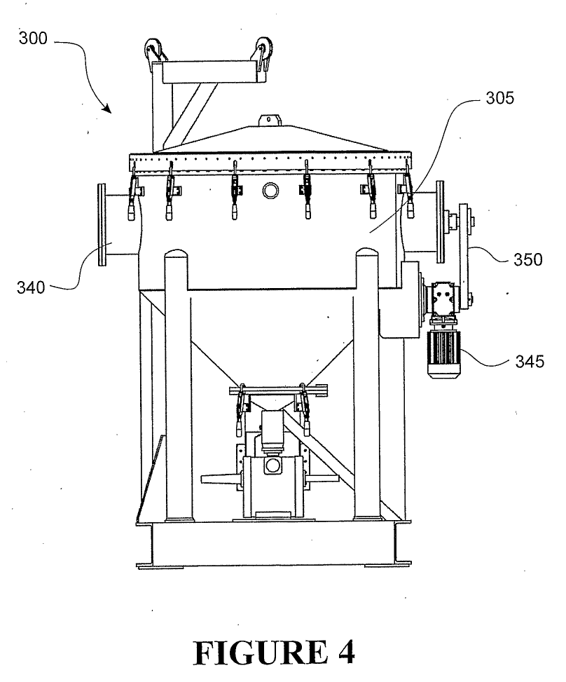

Referring to FIG. 4, a rotable shaft 340 extends through the vessel 305. The basket is removably attached to the shaft 340. A motor 345 and drive shaft 350 effect a rocking motion to the drive shaft 340. The rocking motion of the drive shaft 340 effects a rocking backwards and forwards of the basket while electromagnetic radiation is applied to the chipped organic material within the basket.

Referring again to FIG. 3, the vessel 305 has a generally conical section 350 terminating in a valve 355. A vacuum pump (not shown) is fitted to valve 355. During operation it is expected that resins will be emitted from the chipped organic material during application of the electromagnetic radiation. A heat exchanger 360 causes condensation of these resins and helps maintain optimum conditions in 305. The basket in which the chipped organic material is located has a perforated base to allow the condensed resins to locate within the conical section 350 of the vessel 305. The vacuum pump attached to valve 335 removes the condensed resins from conical section 350.

A benefit of removing the resins from the vacuum vessel 305 is that the resins do not then absorb energy from the electromagnetic radiation that would otherwise be applied to the chipped organic material.

It is also envisaged that the vacuum pump removes oxygen and ambient air from the vessel 305 to prevent combustion of the chipped organic material.

Apparatus 300 further includes a non contact temperature probe (not shown). A further monitoring apparatus monitors the input wave guidance impedance into the vessel 305. The temperature and wave guidance impendance data gathered by the monitors is then used to control the heating process.

It will be appreciated that alternative techniques exist to load the chipped organic material into the vacuum vessel 305 such as a feeder. Alternative techniques for removing the carbon product include an outfeed conveyer belt.

In the apparatus of FIGS. 3 and 4 the carbon product is created by applying electromagnetic radiation from microwave generator 310. Once the chipped organic material is adequately carbonised the electromagnetic radiation ceases. Lid 325 is raised and gantry 320 lifts the basket containing the charcoal product free of the batch vacuum vessel 305.

In particalarly preferred embodiments, the microwave furnace is solar powered to further improve the carbon efficiency of the sequestration process. Other forms of carbon-efficient energy may also be used to power the microwave apparatus 230, for example wind, geothermal, wave or micro-hydro generated energy.

Once the organic material has been effectively carbonised into charcoal, the charcoal will fix the carbon potentially for more than 10³ years. Charcoal is highly resistant to microbial breakdown and once formed is effectively removed from biospheric carbon reservoirs, including the atmosphere and ocean.

As shown at 140 in FIG. 1, once the carbon in the organic material is fixed in the charcoal that has been produced by the method, the charcoal can be stored in sinks. The preferred sinks for the charcoal are natural carbon repositories such as mined and open cast coal mines. Alternatively, the charcoal could be pulverised and placed as slurry into exhausted oil and gas reservoirs. Any sink that provides a moist and cool environment can be used for storage of the charcoal. The charcoal may be buried or deposited in surface deposits.

### Experimental Results

Experimental results from carbonising wood chips in a 1000 watt microwave are provided below:

TABLE 1

| | | Mass after | | Equivalent (net) |
|---|---|---|---|---|
| Time | Mass before | heating | % Mass | CO₂ mass (kg) |
| (mins) | heating (g) | (g) | remaining | fixed |
| 4 | 40 | 20 | 50 | 0.066 |
| 4 | 41 | 22 | 54 | 0.073 |
| 8 | 200 | 89 | 45 | 0.295 |
| 8 | 200 | 88 | 44 | 0.291 |
| 15 | 400 | 188 | 47 | 0.620 |

Once carbonised, carbon concentration values exceed 75% and may go as high as 90%. As can be seen, an optimum mass of 200 g of wood in this experiment resulted in a net fixation of approximately 300 g of CO₂

In a further experiment a 500 mL pyrex bowl was weighed. The bowl was then filled with wood chips of approximately 5×2×0.5 cm in dimension. The bowl and wood chips were then reweighed. The amount of wood subject to the experiment was then determined by the difference in weights between the full bowl and the empty bowl.

A 12,000 W microwave cooker was placed in a fume hood. The fume hood provided venting of air past the microwave and was sufficient to remove any smoke produced ducting the heating process.

For an initial test; the microwave was set to 8 minutes cooking time on the highest power setting. The cooking process was interrupted several times to examine the extent of carbonisation of the wood. Smoke was first observed from the sample after between 2.5 and 3 minutes of cooking time.

The process was interrupted at 5 minutes due to what appeared to be a flame inside the container. The wood was cooled for 20 minutes and then examined to determine the extent of carbonisation. Carbonisation was found to be incomplete. Carbonisation was continued and careful observation revealed that although the wood was glowing, a flame was not present. The volume of smoke diminished 1.5 minutes after the microwave was restarted. Examination of the wood revealed that carbonisation appeared to be complete. Heating was then continued for a further minute with continued observation to see if any changes occurred. There was no observable difference with further heating and carbonisation was assumed to have finished after the reduction in evolution of smoke. This was used as the end point for all subsequent carbonisation, which consisted of uninterrupted heating in the microwave.

The wood and pyrex bowls were weighed to an accuracy of ±0.1 g. Carbonisation was repeated in 500 ml, 1 L and 2 L pyrex bowls. Carbon analyses were determined to ±0.3%. Each sample was carbonised and a repeat carbonisation was performed with an identical wood mass and carbonisation time. The carbon analysis for the uncarbonised wood samples is shown below in Table 2.

TABLE 2

| Sample | Carbon Analysis (%) | Repeated Analysis (%) |
|---|---|---|
| WOOD-A | 45.34 | 45.33 |
| WOOD-B | 45.47 | 45.37 |
| WOOD-C | 45.72 | 45.69 |

TABLE 3

| | | Time for | Electricity | | | | % |
|---|---|---|---|---|---|---|---|
| Bowl | Mass of | carbonisation* | Used** | Mass of | Sample | % | Carbon |
| size | wood (g) | (minutes:seconds) | (kWhr) | charcoal (g) | Code | Carbon | (repeat) |
| 500 | 129.8 | 6:45 | 0.135 | 28.3 | 500-1ra | 77.88 | 77.85 |
| | | | | | 500-1rb | 77.43 | 77.24 |
| | | | | | 500-1rc | 75.95 | 75.99 |
| 500 | 129.8 | 6:45 | 0.135 | 33.9 | 500-2a | 77.35 | 77.62 |
| | | | | | 500-2b | 76.53 | 76.91 |
| | | | | | 500-2c | 76.80 | 77.41 |
| 1000 | 194.1 | 10:30 | 0.210 | 78.8 | 1000-1a | 66.19 | 66.44 |
| | | | | | 1000-1b | 66.40 | 66.56 |
| | | | | | 1000-1c | 66.37 | 66.45 |
| 1000 | 194.1 | 10:30 | 0.210 | 81.6 | 1000-2a | 66.17 | 66.33 |
| | | | | | 1000-2b | 66.28 | 66.43 |
| | | | | | 1000-2c | 65.15 | 65.09 |
| 2000 | 356.5 | 14:00 | 0.280 | 142.5 | 2000-1a | 66.84 | 67.07 |
| | | | | | 2000-1b | 67.66 | 67.70 |
| | | | | | 2000-1c | 66.74 | 66.80 |
| 2000 | 356.5 | 14:00 | 0.280 | 161.2 | 2000-2a | 71.00 | 70.18 |
| | | | | | 2000-2b | 72.90 | 72.10 |
| | | | | | 2000-2c | 70.76 | 70.25 |

Table 4 below shows examination of the mass of carbon produced per kilowatt hour.

TABLE 4

| | Mass of | Average | Mass of | | Mass of carbon |
|---|---|---|---|---|---|
| | charcoal | % | Carbon | Electricity | produced per |
| Sample | (g) | Carbon | (g)* | (kWhr) | kWhr (g/kWhr) |
| 500-1 | 28.3 | 77.06 | 21.8 | 0.135 | 161.5 |
| 500-2 | 33.9 | 77.10 | 26.1 | 0.135 | 193.3 |
| 1000-1 | 78.8 | 66.40 | 52.3 | 0.210 | 249.0 |
| 1000-2 | 81.6 | 65.91 | 53.8 | 0.210 | 256.2 |
| 2000-1 | 142.5 | 67.14 | 95.7 | 0.280 | 341.8 |
| 2000-2 | 161.2 | 71.20 | 114.8 | 0.280 | 410.0 |

Table 5 below shows the percentage of carbon retained from the original sample of wood.

TABLE 5

| | Sample | Maximum possible | Mass of | % Carbon |
|---|---|---|---|---|
| Sample | Mass (g) | carbon mass (g)* | Carbon (g) | retained** |
| 500-1 | 129.8 | 59.0 | 21.8 | 36.9 |
| 500-2 | 129.8 | 59.0 | 26.1 | 44.2 |
| 1000-1 | 194.1 | 88.3 | 52.3 | 59.9 |
| 1000-2 | 194.4 | 88.3 | 53.8 | 60.9 |
| 2000-1 | 356.5 | 162.2 | 95.7 | 59.0 |
| 2000-2 | 356.5 | 162.2 | 114.8 | 70.8 |

It appears from these experiments that the largest sample size is the most efficient with regard to both mass of carbon produced and the percentage of carbon retained from the original sample of wood. The largest sample size produces both the largest amount of carbon per unit of energy used as well as retaining the most carbon from the original wood sample, or losing the least carbon in the carbonisation process.

It is envisaged that charcoal produced by the methods described above and deposited in a carbon sink will have a value under carbon trading schemes such as the European Union Emission Trading Scheme (EU ETS), other mechanisms of the Kyoto Protocol or international agreements, or individual domestic national greenhouse gas mitigation schemes. Under this type of scheme the sequestered carbon produced by the invention may have a value that is calculated in terms of “carbon credits”. This value will increase as more stringent reductions in carbon dioxide are required.

If not used to sequester carbon dioxide, the charcoal can be utilised as an energy source (including the generation of refined petroluera-equivalent products), to encourage reforestation schemes (helping to sustain forests) or help form terra preta soils (fertile carbon rich soils similar to those found in the Amazon region), thereby raising agricultural production.

The foregoing describes the invention including preferred forms thereof. Modifications and improvements as would be obvious to those skilled in the art are intended to be incorporated in the scope hereof, as defined by the accompanying claims.

1. A method for sequestering carbon dioxide comprising:
cutting organic material into chips having dimensions in the range of 0.5 cm to 5 cm;
carbonising the chips of organic material by applying microwave energy; and
storing the resulting charcoal in a carbon sink.

2. The method of claim 1 wherein at least some of the chips have a volume of at least 5 cm³.

3. The method of claim 1 or claim 2 further comprising selecting organic material that is well-suited to fix carbon.

4. The method of claim 3 wherein the organic material is plant material.

5. The method of claim 1 wherein the organic material is cut into chips in a chipper apparatus fuelled by bio-fuel.

6. The method of claim 1 wherein the chips of organic material are held in oxygen-restricting containment when the microwave energy is applied.

7. The method of claim 1 wherein the microwave energy is applied to the chips of organic material in a solar-powered microwave apparatus.

8. The method of claim 1 wherein the carbon sink is a coal mine shaft.

9. The method of any one of claim 1 wherein the carbon sink is an open cast working mine.

10. The method of claim 1 wherein the carbon sink is an exhausted oil reservoir.

11. The method of any one of claim 1 wherein the carbon sink is in the form of terra preta soils

12. A method for sequestering carbon dioxide comprising:
machine-chipping plant material into chips having dimensions in the range of 0.5 cm to 5 cm, wherein the machinery used to chip the plant material is run on biofuel; and
carbonising the chipped plant material in a solar-powered microwave oven; and
storing the resulting charcoal in a carbon sink.

13. The method of claim 12 wherein at least some of the chips have a volume of at least 5 cm³.
